(19) United States
(12) Patent Application Publication
(10) Pub. No.: US 2026/0084814 A1
(43) Pub. Date: Mar. 26, 2026

(54) COUNTERMEASURE DISPENSER SYSTEM

(71) Applicant: BAE Systems Information and Electronic Systems Integration Inc., Nashua, NH (US)

(72) Inventors: John R. Franzini, Hollis, NH (US); Emily M. Coughlin, Litchfield, NH (US)

(73) Assignee: BAE Systems Information and Electronic Systems Integration Inc., Nashua, NH (US)

(21) Appl. No.: 18/891,093

(22) Filed: Sep. 20, 2024

(51) Int. Cl. B64D 7/00

(52) U.S. Cl. CPC B64D 7/00

(57) ABSTRACT

A payload module for a countermeasure dispenser system is provided. The payload module, according to an embodiment, includes four exterior walls and a plurality of interior walls configured to subdivide the payload module into a plurality of square tubes. The exterior walls and the interior walls comprise one or more monolithic and continuous bodies of material which are fabricated using an extrusion process. The payload module further includes four triangular corner structures attached to a front side of the payload module such that each of the exterior walls connects to a pair of the triangular corner structures. The one or more materials may comprise nylon, polyether ether ketone, and aluminum. The thickness of the exterior walls is greater than the thickness of the interior walls for strength and weight reduction.

### STATEMENT OF GOVERNMENT INTEREST

This invention was made with United States Government assistance under Contract No. COMBLD 23YDA. The United States Government has certain rights in this invention.

### FIELD OF DISCLOSURE

The present disclosure relates to countermeasure dispenser systems, and more particularly to an extruded payload module for a countermeasure dispenser system.

### BACKGROUND

Military and defense platforms such as aircraft, ships and ground vehicles can deploy various techniques for self-protection against hostile forces. These techniques are referred to as countermeasures and one such technique is the deployment of flares to evade or otherwise interfere with the tracking systems of adversarial platforms, including missiles and the like. The flares may be stored for deployment in a housing, or structure of some type, that is mounted to the aircraft.

### BRIEF DESCRIPTION OF THE DRAWINGS

FIG. 1 illustrates a deployment of a countermeasure dispenser system, in accordance with certain embodiments of the present disclosure.

FIG. 2 illustrates one example payload module of the countermeasure dispenser system of FIG. 1, configured in accordance with certain embodiments of the present disclosure.

FIG. 3 illustrates details of a tube of the payload module of FIG. 2, configured in accordance with certain embodiments of the present disclosure.

FIG. 4 illustrates another example payload module of the countermeasure dispenser system of FIG. 1, configured in accordance with certain embodiments of the present disclosure.

FIG. 5 illustrates details of a first tube type of the payload module of FIG. 4, configured in accordance with certain embodiments of the present disclosure.

FIG. 6 illustrates details of a second tube type of the payload module of FIG. 4, configured in accordance with certain embodiments of the present disclosure.

FIG. 7 illustrates another example payload module of the countermeasure dispenser system of FIG. 1, configured in accordance with certain embodiments of the present disclosure.

FIG. 8 illustrates details of a mechanical interlock of the payload module of FIG. 7, configured in accordance with certain embodiments of the present disclosure.

FIG. 9 illustrates details of a first tube type of the payload module of FIG. 7, configured in accordance with certain embodiments of the present disclosure.

FIG. 10 illustrates details of a second tube type of the payload module of FIG. 7, configured in accordance with certain embodiments of the present disclosure.

FIG. 11 is a flowchart illustrating a methodology for fabrication of a payload module, in accordance with an embodiment of the present disclosure.

Although the following Detailed Description will proceed with reference being made to illustrative embodiments, many alternatives, modifications, and variations thereof will be apparent in light of this disclosure.

### DETAILED DESCRIPTION

A payload module for a countermeasure dispenser system is provided herein. As noted above, aircraft may employ various countermeasure techniques for self-protection against adversaries. One such technique is to launch canisters containing flares or chaff to interfere with the tracking systems of a missile or other threat in pursuit of the aircraft. These canisters may be stored in tubes of the payload module from which they may be launched when needed. In accordance with an embodiment of the present disclosure, a payload module is disclosed which is fabricated as a single piece using an extrusion process applied to high strength plastic and/or metallic (e.g., aluminum) materials. In one such example case, the payload module includes four triangular corner structures and four exterior walls, each exterior wall connecting a pair of the triangular corner structures. The payload module also includes a plurality of interior walls which subdivide the payload module into a plurality of square or rectangular tubes. The tubes are configured to store a countermeasure device, and to allow the countermeasure device to be dispensed therefrom. The payload module is fabricated as an extrusion of one or more lightweight materials. The one or more materials may comprise, for example, nylon, polyether ether ketone (PEEK), and/or aluminum. The thickness of the exterior walls may be greater than the thickness of the interior walls, according to some such examples. It will be appreciated that the techniques described herein may provide a payload module with reduced weight and greater structural strength, compared to designs that might use, for instance, syntactic foam and carbon fiber, which would be more difficult and costly to manufacture. Numerous embodiments and applications will be apparent in light of this disclosure.

### System Architecture

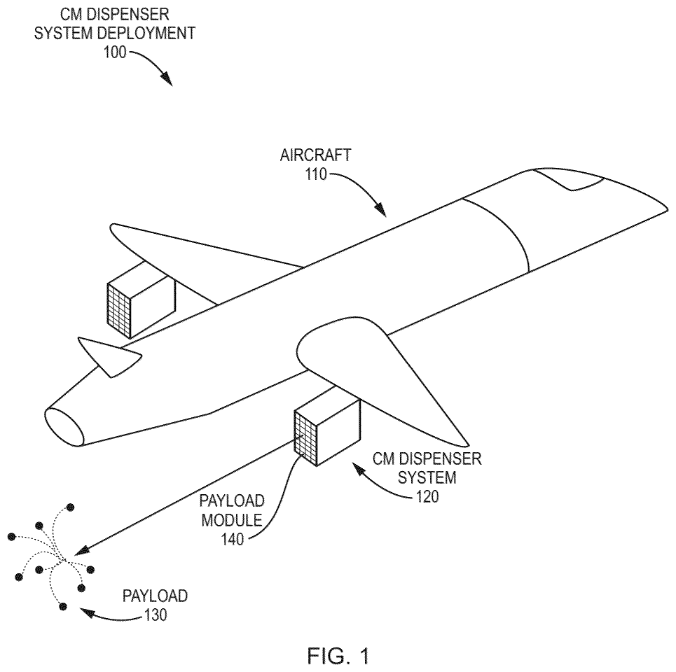

FIG. 1 illustrates a deployment 100 of a countermeasure dispenser system, in accordance with certain embodiments of the present disclosure. The deployment 100 is shown to include a countermeasure dispenser system 120 mounted to an aircraft 110. The aircraft may be any type of aircraft including a helicopter or a fixed wing aircraft. In this illustration the countermeasure dispenser system 120 is shown to be mounted or otherwise attached to the wings of the aircraft, but the countermeasure dispenser system 120 may be positioned at any suitable location on the aircraft. The countermeasure dispenser system 120 includes a payload module 140. The payload module 140 will be described in greater detail below, but at a high level, the module comprises a number of tubes or enclosures, each configured to store a canister or payload containing a countermeasure device such as, for example, a flare. The countermeasure dispenser system 120 may include an explosive mechanism (e.g., a squib) and ignition control for each tube so that the payloads may be launched from the tubes on command or when otherwise needed. One payload 130 is shown after launch which may be a flare burst or explosion of chaff particles.

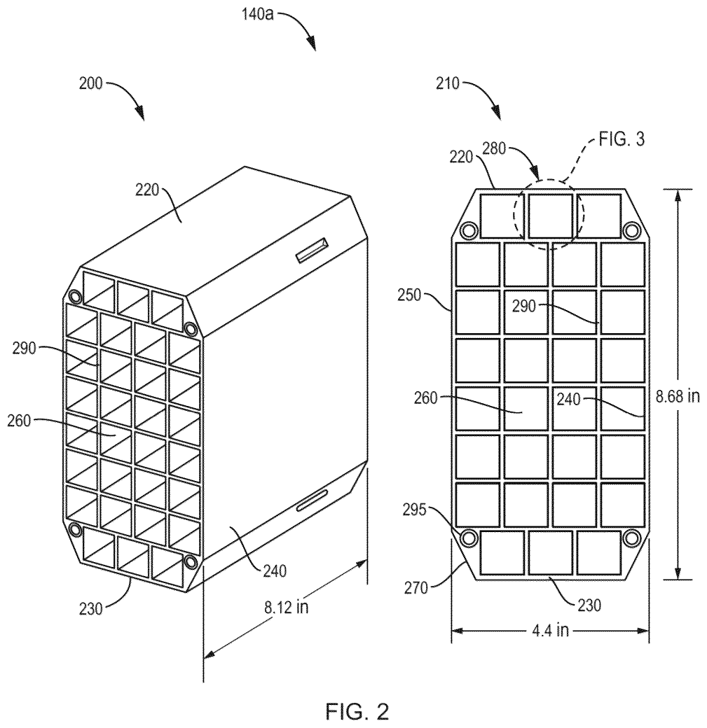

FIG. 2 illustrates one example payload module 140a of the countermeasure dispenser system 120 of FIG. 1, configured in accordance with certain embodiments of the present disclosure. A 3D view 200 is shown to include a top wall 220, a bottom wall 230, right side wall 240, and interior walls 290. The left side wall is hidden in this view. The arrangement of interior and exterior walls forms cavities or tubes 260 which are configured to hold the countermeasure devices (e.g., canisters). A planar front view 210 is also provided which shows top wall 220, bottom wall 230, right side wall 240, left side wall 250, and interior walls 290. In this embodiment, the interior walls 290 are configured to subdivide the payload module into 30 tubes 260, which in this example are square. The planar view also references four triangular corner structures 270, each of which includes a cylindrical channel 295 configured to receive bolts which may be used to fasten the payload module to the countermeasure dispenser system 120. The four triangular corner structures 270 also provide increased structural strength to the payload module 140a.

The payload module 140a in this example is fabricated as a monolithic and continuous body of extruded material. An extrusion process may be performed, for example, by employing a press to force a material through a die to create a monolithic and continuous body of material having a cross sectional shape that is imparted by the die. In this embodiment, the material is a nylon grade material. In some embodiments, the nylon grade material is Resmart Ultra nylon 6/6L. The material in one example is extruded to near length (e.g., slightly greater than the desired length) and then cut off and machined to a final desired dimension. In some embodiments, the final desired dimensions of the payload module 140a are height 8.68 inches, width 4.4 inches, and depth 8.12 inches, to within a tolerance of one percent. In some embodiments, the weight of the payload module 140a is 2.425 pounds to within a tolerance of one percent.

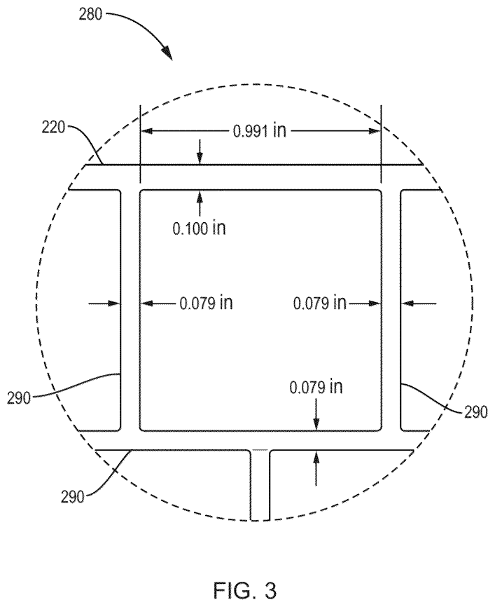

FIG. 3 illustrates details of one of the exterior tubes 280 of the payload module 140a of FIG. 2, configured in accordance with certain embodiments of the present disclosure. The exterior tube 280 is shown to include the exterior top wall 220, and interior left, right, and bottom walls 290. In this embodiment, the exterior wall is shown to be 0.100 inches and the interior walls are shown to be 0.079 inches. The additional thickness of the exterior walls, compared to the interior walls, provides increased structural strength for the payload module. The thinner interior walls allow for reduced weight of the payload module. In this embodiment, the distance between interior walls is shown to be 0.991 inches.

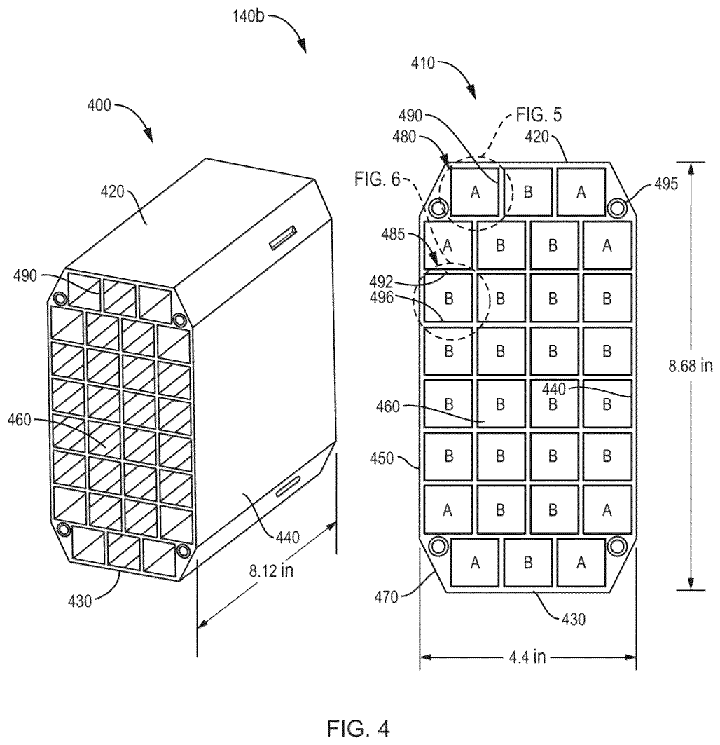

FIG. 4 illustrates another example payload module 140b of the countermeasure dispenser system 120 of FIG. 1, configured in accordance with certain embodiments of the present disclosure. A 3D view 400 is shown to include a top wall 420, a bottom wall 430, right side wall 440, and interior walls 490. The left side wall is hidden in this view. The arrangement of interior and exterior walls forms cavities or tubes 460 which are configured to hold the countermeasure devices (e.g., canisters). A planar front view 410 is also provided which shows top wall 420, bottom wall 430, right side wall 440, left side wall 450, and interior walls 490. In this embodiment, the interior walls 490 are configured to subdivide the payload module into 30 square tubes 460. In this embodiment, the payload module 140b comprises two types of tubes: corner tubes 480 labeled “A” and non-corner tubes 485 labeled “B,” as will be described below. The planar view also references four triangular corner structures 470, each of which includes a cylindrical channel 495 configured to receive bolts which may be used to fasten the payload module to the countermeasure dispenser system 120. The four triangular corner structures 470 also provide increased structural strength to the payload module 140b.

The payload module 140b is fabricated as a monolithic and continuous body of extruded material. In this embodiment, the material is a polyether ether ketone (PEEK) material. In some embodiments, the PEEK material is of a grade KT-820. The material is extruded to near length (e.g., slightly greater than the desired length) and then cut off and machined to a final desired dimension. In some embodiments, the final desired dimensions of the payload module 140b are height 8.68 inches, width 4.4 inches, and depth 8.12 inches, to within a tolerance of one percent. In some embodiments, the weight of the payload module 140b is 2.593 pounds to within a tolerance of one percent.

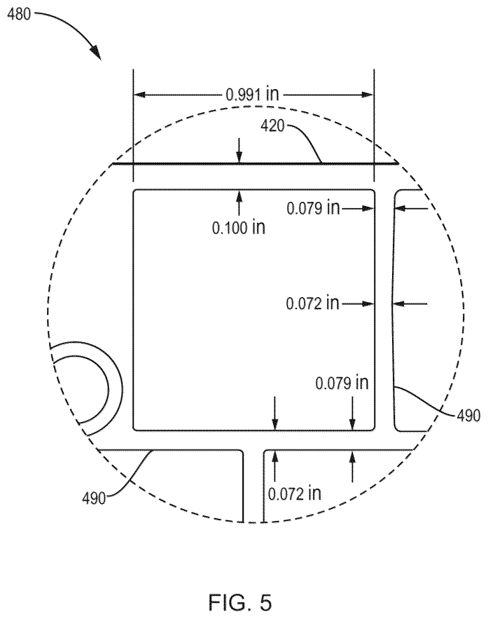

FIG. 5 illustrates details of the first tube type 480 of the payload module 140b of FIG. 4, configured in accordance with certain embodiments of the present disclosure. The first tube type 480 (e.g., the corner tube type “A” of FIG. 4) is shown to include the exterior top wall 420 and interior right and bottom walls 490. The interior left wall in this example is part of the triangular corner structure 470. In this embodiment, the exterior top wall 420 is shown to be 0.100 inches and the two interior walls 490 are shown to vary in thickness from 0.079 inches at the thickest portions to 0.072 inches at the thinnest portion. The additional thickness of the exterior walls, compared to the interior walls, provides increased structural strength for the payload module. The thinner interior walls allow for reduced weight of the payload module.

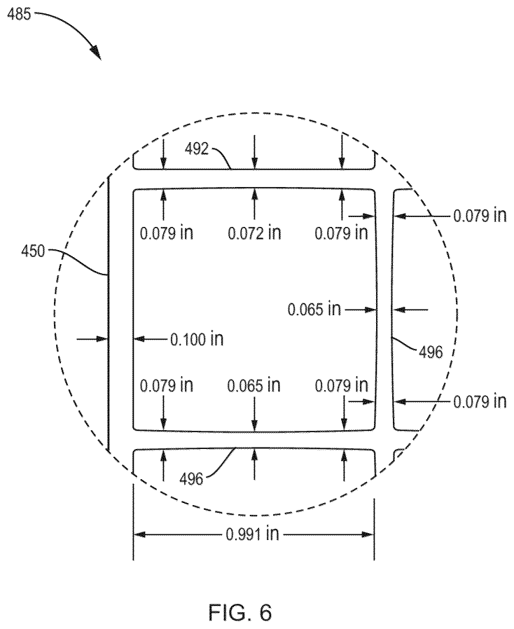

FIG. 6 illustrates details of the second tube type 485 of the payload module 140b of FIG. 4, configured in accordance with certain embodiments of the present disclosure. The second tube type 485 (e.g., the non-corner tube type “B” of FIG. 4) is shown to include an exterior side wall 450, an interior wall 492 which is shared with a first tube type 480, and two other interior walls 496. In this embodiment, the exterior side wall 450 is shown to be 0.100 inches. The interior wall 492 is shown to vary in thickness from 0.079 inches at the thickest portions to 0.072 inches at the thinnest portion. The two other interior walls 496 are also shown to vary from 0.079 inches at the thickest portions to 0.065 inches at the thinnest portion. The additional thickness of the exterior walls, compared to the interior walls, provides increased structural strength for the payload module. The interior walls 496 of the of the second tube type 485 are allowed to be thinner (e.g., as thin as 0.065 inches in places) than the interior walls 490 of the of the first tube type 480 (e.g., 0.072 inches) because the corner tubes are subject to greater stresses. These thinner interior walls allow for reduced weight of the payload module. Stated differently, the A tubes 480 that are directly proximate to the cylindrical channel 495 that receives the bolts to secure the payload module to the countermeasure dispenser system 120 have a consistent interior wall, unlike the B tubes 485. The interior walls 492 and 496 that are not proximate the cylindrical channel vary in thickness from a smaller thickness than the interior wall 490 to a thicker portion that has a larger thickness than interior wall 490.

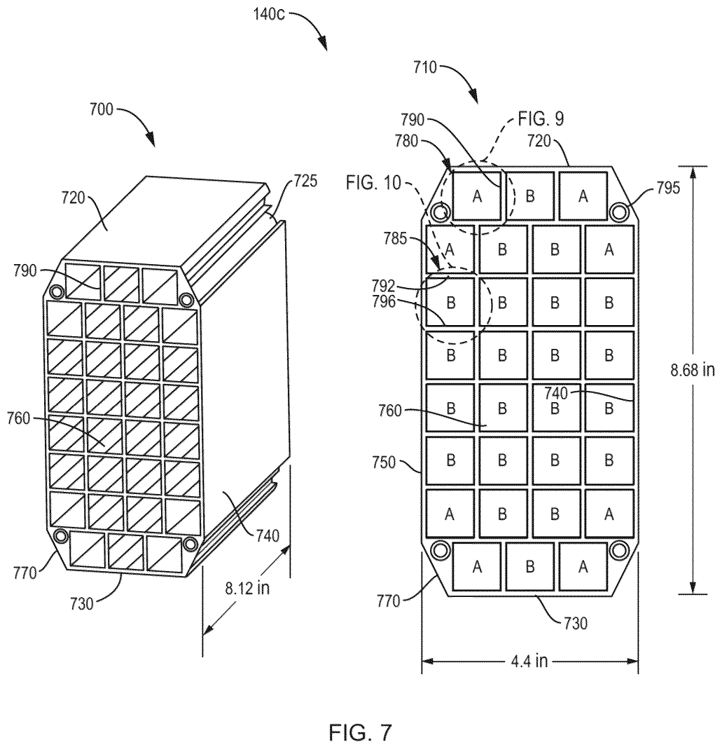

FIG. 7 illustrates another example payload module 140c of the countermeasure dispenser system 120 of FIG. 1, configured in accordance with certain embodiments of the present disclosure. A 3D view 700 is shown to include a top wall 720, a bottom wall 730, right side wall 740, interior walls 790, and aluminum rails 725 oriented along a longitudinal axis extending from each of the corner structures 770 at the front side of the payload module to the corresponding corner structures at the rear side of the payload module. In some embodiments, the aluminum rails 725 may be hollow to reduce weight. The left side wall is hidden in this view. The arrangement of interior and exterior walls forms cavities or tubes 760 which are configured to hold the countermeasure devices (e.g., canisters). A planar front view 710 is also provided which shows top wall 720, bottom wall 730, right side wall 740, left side wall 750, and interior walls 790. In this embodiment, the interior walls 790 are configured to subdivide the payload module into 30 square tubes 760. In this embodiment, the payload module 140c comprises two types of tubes: corner tubes 780 labeled “A” and non-corner tubes 785 labeled “B,” as will be described below. The planar view also references four triangular corner structures 770, each of which includes a cylindrical channel 795 configured to receive bolts which may be used to fasten the payload module to the countermeasure dispenser system 120. The four triangular corner structures 770 also provide increased structural strength to the payload module 140b and provide endpoints for the aluminum rails 725.

In some embodiments, the payload module 140c is fabricated as a coextrusion of two materials: PEEK and aluminum. A coextrusion process may be performed, for example, by employing a first press to force a first material through a first region of a die while simultaneously (or near simultaneously) employing a second press to force a second material through a second region of the die. The result is to create two adjacent, or layered, monolithic and continuous bodies of material that are fused or otherwise coupled together by the coextrusion process and have a combined cross-sectional shape that is imparted by the die. Two presses may be used because the extrusion flow rate may be different for each material, for example due to thermal properties and strength properties of the different materials. In this embodiment, the rails 725 are formed from the coextruded aluminum and the walls 720, 730, 740, 750, and 790 are formed from the coextruded PEEK. Machined aluminum corner structures 770 may then be assembled to the combined extruded product.

In some other embodiments, the payload module 140c is fabricated as two extrusions. A first extrusion of PEEK through a first die creates a monolithic and continuous body of PEEK to form the walls 720, 730, 740, 750, and 790. A second extrusion of aluminum through a second die creates a monolithic and continuous body of aluminum to form the rails 725. The extruded PEEK and aluminum may then be bonded together with an epoxy or other suitable bonding method. Machined aluminum corner structures 770 may then be assembled to the combined extruded product.

In some embodiments, the PEEK material is of a grade KT-820 and the aluminum is of a grade 6061-T6. The material is extruded to near length (e.g., slightly greater than the desired length) and then cut off and machined to a final desired dimension. In some embodiments, the final desired dimensions of the payload module 140c are height 8.68 inches, width 4.4 inches, and depth 8.12 inches, to within a tolerance of one percent. In some embodiments, the weight of the payload module 140c is 2.587 pounds to within a tolerance of one percent.

In some embodiments, a ¼″ diameter steel bolt (not shown) is disposed as an additional element within each of the four triangular corner structures 770 and oriented along the longitudinal axis extending from the front side of the payload module to the rear side of the payload module. The steel bolt may be added to provide additional strength to the payload module 140c.

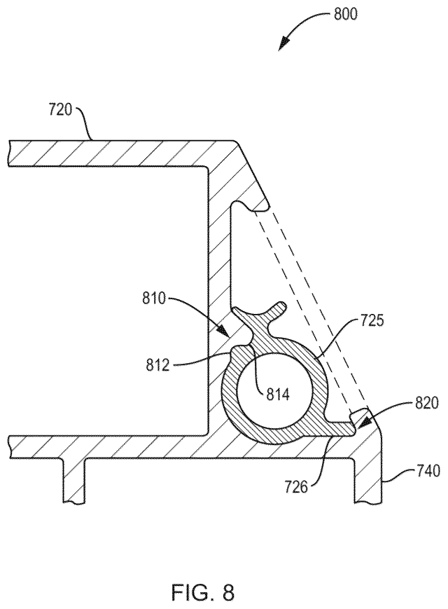

FIG. 8 illustrates details of a mechanical interlock 800 of the payload module 140c of FIG. 7, configured in accordance with certain embodiments of the present disclosure. Mechanical interlock 800 or keying, similar to the fitting together of jigsaw puzzle pieces, may be used to securely couple or otherwise keep the aluminum and PEEK components in contact. For example, a first mechanical interlock 810 is shown along with a second mechanical interlock 820. The first interlock 810 has a recessed portion or nub 812 proximate an extended protrusion 814 that mates with the rails 725. Likewise, the second mechanical interlock 820 includes an angular recess that mates with a leg or extension 726 from the rails 725. In the case of fabrication as two separate extrusions, the extruded aluminum rails 725 may be slid into their position next to the PEEK wall structures 720 and 740, as shown and the interlocks 810 and 820 can secure the aluminum in place. The interlocks may also serve this function of providing additional bonding strength in the case of fabrication as a coextrusion process where the aluminum 725 is coextruded into position within the interlocks 810 and 820. Other such interlocking examples may be configured differently but to the same end, such that the aluminum rails 725 can be mechanically coupled to complementary-shaped PEEK wall structures. In some cases, a bonding material may also be used. For example, one or both of the engaging surfaces of the aluminum rails and PEEK wall structures can be coated with adhesive or other bonding agent prior to sliding the rails into their respective positions along the complementary-shaped PEEK wall structures. In some such cases, a curing process may also be carried out.

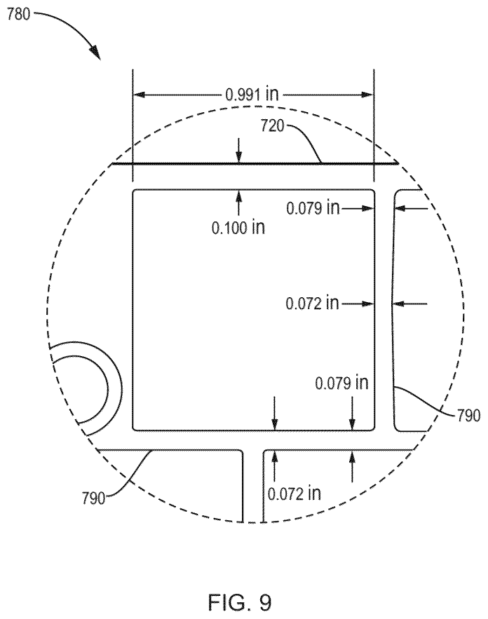

FIG. 9 illustrates details of the first tube type 780 of the payload module 140c of FIG. 7, configured in accordance with certain embodiments of the present disclosure. The first tube type 780 (e.g., the corner tube type “A” of FIG. 7) is the same as the first tube type 480 illustrated in FIG. 5 and is shown to include the exterior top wall 720 and interior right and bottom walls 790. The interior left wall in this example is part of the triangular corner structure 770. In this embodiment, the exterior top wall 720 is shown to be 0.100 inches and the two interior walls 790 are shown to vary in thickness from 0.079 inches at the thickest portions to 0.072 inches at the thinnest portion. The additional thickness of the exterior walls, compared to the interior walls, provides increased structural strength for the payload module. The thinner interior walls allow for reduced weight of the payload module.

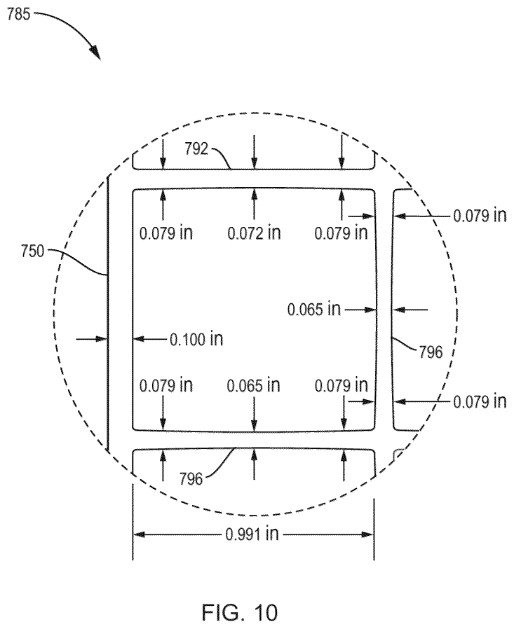

FIG. 10 illustrates details of the second tube type 785 of the payload module 140c of FIG. 7, configured in accordance with certain embodiments of the present disclosure. The second tube type 785 (e.g., the non-corner tube type “B” of FIG. 7) is the same as the second tube type 485 illustrated in FIG. 6 and is shown to include an exterior side wall 750, an interior wall 792 which is shared with a first tube type 780, and two other interior walls 796.

In this embodiment, the exterior side wall 750 is shown to be 0.100 inches. The interior wall 792 is shown to vary in thickness from 0.079 inches at the thickest portions to 0.072 inches at the thinnest portion. The two other interior walls 796 are also shown to vary from 0.079 inches at the thickest portions to 0.065 inches at the thinnest portion. The additional thickness of the exterior walls, compared to the interior walls, provides increased structural strength for the payload module. The interior walls 796 of the of the second tube type 785 are allowed to be thinner (e.g., as thin as 0.065 inches in places) than the interior walls 790 of the of the first tube type 780 (e.g., 0.072 inches) because the corner tubes are subject to greater stresses. These thinner interior walls allow for reduced weight of the payload module.

### Methodology

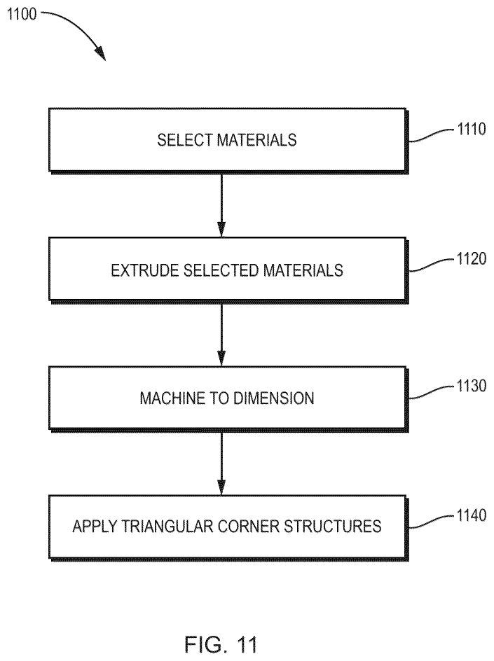

FIG. 11 is a flowchart illustrating a methodology 1100 for fabrication of a payload module, in accordance with an embodiment of the present disclosure. As can be seen, example method 1100 includes a number of phases and sub-processes, the sequence of which may vary from one embodiment to another. However, when considered in aggregate, these phases and sub-processes form a process for fabrication of a payload module, in accordance with certain of the embodiments disclosed herein, for example as illustrated in FIGS. 1-10, as described above. The correlation of the various functions shown in FIG. 11 to the specific components illustrated in the figures, is not intended to imply any structural and/or use limitations. Numerous variations and alternative configurations will be apparent in light of this disclosure.

In one embodiment, method 1100 commences, at operation 1110, by selecting materials for the payload module. In some embodiments, the materials may comprise one or more of nylon, PEEK, and aluminum.

At operation 1120, the payload module is formed by extruding the selected materials into a shape comprising four exterior walls, and a plurality of interior walls configured to subdivide the payload module into a plurality of square tubes, as shown in FIGS. 2, 4, and 7. The extrusion process is configured so that the resulting thickness of the exterior walls is greater than the thickness of the interior walls. In some embodiments, the selected materials may include one or more of nylon, polyether ether ketone, and aluminum.

At operation 1130, the extruded materials are cut off and machined to a final desired dimension.

At operation 1140, four triangular corner structures (e.g., 2,70, 470, and 770) are fabricated and applied such that each exterior wall connects to a pair of the triangular corner structures, as shown in FIGS. 2, 4, and 7.

In some embodiments, additional operations may be performed, as previously described in connection with the system. For example, the extrusion process may also dispose aluminum rails oriented along a longitudinal axis extending from the front side of the payload module to the rear side of the payload module. In some embodiments, the exterior walls may be extruded to include a mechanical interlock to securely join the aluminum rails to the payload module.

In some embodiments, a steel bolt may be disposed within each of the four triangular corner structures and oriented along a longitudinal axis extending from the front side of the payload module to the rear side of the payload module.

In some embodiments, the thickness of the exterior walls is in the range of 0.09 inches to 0.11 inches and the thickness of the interior walls is in the range of 0.060 inches to 0.085 inches.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still cooperate or interact with each other.

Numerous specific details have been set forth herein to provide a thorough understanding of the embodiments. It will be understood, however, that other embodiments may be practiced without these specific details, or otherwise with a different set of details. It will be further appreciated that the specific structural and functional details disclosed herein are representative of example embodiments and are not necessarily intended to limit the scope of the present disclosure. In addition, although the subject matter has been described in language specific to structural features and/or methodological acts, it is to be understood that the subject matter defined in the appended claims is not necessarily limited to the specific features or acts described herein. Rather, the specific features and acts described herein are disclosed as example forms of implementing the claims.

### Further Example Embodiments

The following examples pertain to further embodiments, from which numerous permutations and configurations will be apparent.
Example 1 is a payload module comprising: four exterior walls; a plurality of interior walls configured to subdivide the payload module into a plurality of square tubes, wherein the exterior walls and the interior walls comprise one or more monolithic and continuous bodies of material; and four triangular corner structures attached to a front side of the payload module such that each of the exterior walls connects to a pair of the triangular corner structures.
Example 2 includes the module of Example 1, wherein the one or more monolithic and continuous bodies of material comprise a first monolithic and continuous body of a first material, and a second monolithic and continuous body of a second material different from the first material.
Example 3 includes the module of Example 2, wherein the first material comprises a plastic and the second material comprises a metal.
Example 4 includes the module of Example 2, wherein the first material comprises nylon or polyether ether ketone and the second material comprises aluminum.
Example 5 includes the module of any of Examples 1-4, wherein the one or more monolithic and continuous bodies of material comprise mechanical interlocks configured to bond one of the one or more monolithic and continuous bodies of material to another of the one or more monolithic and continuous bodies of material.
Example 6 includes the module of any of Examples 1-5, wherein the payload module comprises a bonding agent between the one or more monolithic and continuous bodies of material, the bonding agent configured to bond the one or more monolithic and continuous bodies of material to each other.
Example 7 includes the module of any of Examples 1-6, wherein the four triangular corner structures comprise aluminum.
Example 8 includes the module of any of Examples 1-7, further comprising a steel bolt disposed within each of the four triangular corner structures and oriented along a longitudinal axis extending from the front side of the payload module to a rear side of the payload module.
Example 9 includes the module of any of Examples 1-8, wherein a thickness of the exterior walls is greater than a thickness of the interior walls and at least some of the interior walls have a varying thickness.
Example 10 includes the module of any of Examples 1-9, wherein a thickness of the exterior walls is in the range of 0.09 inches to 0.11 inches and a thickness of the interior walls is in the range of 0.060 inches to 0.085 inches.
Example 11 includes the module of any of Examples 1-10, wherein the interior walls are configured to subdivide the payload module into 30 square tubes.
Example 12 includes the module of any of Examples 1-11, wherein a weight of the payload module is less than 2.6 pounds.
Example 13 is a countermeasure dispenser system comprising: a payload module comprising four exterior walls, a plurality of interior walls configured to subdivide the payload module into a plurality of square tubes, wherein the exterior walls and the interior walls comprise one or more monolithic and continuous bodies of material, and four triangular corner structures attached to a front side of the payload module such that each of the exterior walls connects to a pair of the triangular corner structures; and a plurality of explosive charges configured to launch a countermeasure device, each of the explosive charges contained in one of the square tubes.
Example 14 includes the system of Example 13, wherein the one or more monolithic and continuous bodies of material comprises one or more extruded materials and the materials comprise one or more of nylon, polyether ether ketone, and/or aluminum.
Example 15 includes the system of any of Examples 13 or 14, wherein a thickness of the exterior walls is greater than a thickness of the interior walls and at least some of the interior walls have a varying thickness.
Example 16 is a method for fabrication of a payload module, the method comprising: extruding one or more materials into a shape comprising four exterior walls, and a plurality of interior walls configured to subdivide the payload module into a plurality of square tubes; and applying four triangular corner structures such that each exterior wall connects a pair of the triangular corner structures.
Example 17 includes the method of Example 16, wherein a thickness of the exterior walls is greater than a thickness of the interior walls and at least some of the interior walls have a varying thickness.
Example 18 includes the method of Examples 16 or 17, wherein the one or more materials comprise one or more of nylon, polyether ether ketone, and aluminum.
Example 19 includes the method of any of Examples 16-18, further comprising disposing a steel bolt within each of the four triangular corner structures and oriented along a longitudinal axis extending from a front side of the payload module to a rear side of the payload module.
Example 20 includes the method of any of Examples 16-19, wherein a thickness of the exterior walls is in the range of 0.09 inches to 0.11 inches and a thickness of the interior walls is in the range of 0.060 inches to 0.085 inches.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and embodiments have been described herein. The features, aspects, and embodiments are susceptible to combination with one another as well as to variation and modification, as will be appreciated in light of this disclosure. The present disclosure should, therefore, be considered to encompass such combinations, variations, and modifications. It is intended that the scope of the present disclosure be limited not by this detailed description, but rather by the claims appended hereto. Future filed applications claiming priority to this application may claim the disclosed subject matter in a different manner and may generally include any set of one or more elements as variously disclosed or otherwise demonstrated herein.

What is claimed is:

1. A payload module comprising:
four exterior walls;
a plurality of interior walls configured to subdivide the payload module into a plurality of square tubes, wherein the exterior walls and the interior walls comprise one or more monolithic and continuous bodies of material; and
four triangular corner structures attached to a front side of the payload module such that each of the exterior walls connects to a pair of the triangular corner structures.

2. The module of claim 1, wherein the one or more monolithic and continuous bodies of material comprise a first monolithic and continuous body of a first material, and a second monolithic and continuous body of a second material different from the first material.

3. The module of claim 2, wherein the first material comprises a plastic and the second material comprises a metal.

4. The module of claim 2, wherein the first material comprises nylon or polyether ether ketone and the second material comprises aluminum.

5. The module of claim 1, wherein the one or more monolithic and continuous bodies of material comprise mechanical interlocks configured to bond one of the one or more monolithic and continuous bodies of material to another of the one or more monolithic and continuous bodies of material.

6. The module of claim 1, wherein the payload module comprises a bonding agent between the one or more monolithic and continuous bodies of material, the bonding agent configured to bond the one or more monolithic and continuous bodies of material to each other.

7. The module of claim 1, wherein the four triangular corner structures comprise aluminum.

8. The module of claim 1, further comprising a steel bolt disposed within each of the four triangular corner structures and oriented along a longitudinal axis extending from the front side of the payload module to a rear side of the payload module.

9. The module of claim 1, wherein a thickness of the exterior walls is greater than a thickness of the interior walls and at least some of the interior walls have a varying thickness.

10. The module of claim 1, wherein a thickness of the exterior walls is in the range of 0.09 inches to 0.11 inches and a thickness of the interior walls is in the range of 0.060 inches to 0.085 inches.

11. The module of claim 1, wherein the interior walls are configured to subdivide the payload module into 30 square tubes.

12. The module of claim 1, wherein a weight of the payload module is less than 2.6 pounds.

13. A countermeasure dispenser system comprising:
a payload module comprising
four exterior walls,
a plurality of interior walls configured to subdivide the payload module into a plurality of square tubes, wherein the exterior walls and the interior walls comprise one or more monolithic and continuous bodies of material, and
four triangular corner structures attached to a front side of the payload module such that each of the exterior walls connects to a pair of the triangular corner structures; and
a plurality of explosive charges configured to launch a countermeasure device, each of the explosive charges contained in one of the square tubes.

14. The system of claim 13, wherein the one or more monolithic and continuous bodies of material comprises one or more extruded materials and the materials comprise one or more of nylon, polyether ether ketone, and/or aluminum.

15. The system of claim 13, wherein a thickness of the exterior walls is greater than a thickness of the interior walls and at least some of the interior walls have a varying thickness.

16. A method for fabrication of a payload module, the method comprising:
extruding one or more materials into a shape comprising
four exterior walls, and
a plurality of interior walls configured to subdivide the payload module into a plurality of square tubes; and
applying four triangular corner structures such that each exterior wall connects a pair of the triangular corner structures.

17. The method of claim 16, wherein a thickness of the exterior walls is greater than a thickness of the interior walls and at least some of the interior walls have a varying thickness.

18. The method of claim 16, wherein the one or more materials comprise one or more of nylon, polyether ether ketone, and aluminum.

19. The method of claim 16, further comprising disposing a steel bolt within each of the four triangular corner structures and oriented along a longitudinal axis extending from a front side of the payload module to a rear side of the payload module.

20. The method of claim 16, wherein a thickness of the exterior walls is in the range of 0.09 inches to 0.11 inches and a thickness of the interior walls is in the range of 0.060 inches to 0.085 inches.
